(19) United States
(12) Patent Application Publication
(10) Pub. No.: US 2017/0293844 A1
(43) Pub. Date: Oct. 12, 2017

(54) HUMAN-MACHINE COLLABORATIVE OPTIMIZATION VIA APPRENTICESHIP SCHEDULING

(71) Applicant: Massachusetts Institute of Technology, Cambridge, MA (US)

(72) Inventors: Matthew Craig Gombolay, Cambridge, MA (US); Julie Ann Shah, Boston, MA (US)

(21) Appl. No.: 15/481,121

(22) Filed: Apr. 6, 2017

Related U.S. Application Data
(60) Provisional application No. 62/318,880, filed on Apr. 6, 2016.

(51) Int. Cl. G06N 5/04; G06N 99/00

(52) U.S. Cl. CPC G06N 5/04; G06N 99/005

(57) ABSTRACT

Domain expert heuristics are captured within a computational framework for a task scheduling system. One or more classifiers are trained to predict (i) whether a first action should be scheduled instead of a second action using pairwise comparisons between actions scheduled by a demonstrator at particular times and actions not scheduled by the demonstrator at the particular times, and (ii) whether a particular action should be scheduled for a particular agent at a particular time. The system then generates a schedule for a set of actions to be performed by a plurality of agents using a plurality of resources over a plurality of time steps, by using the one or more classifiers to determine (i) a highest priority action in the set of actions, and (ii) whether the highest priority action should be scheduled for a particular agent at a particular time step.

### CROSS-REFERENCE TO RELATED APPLICATION

This application claims priority to and the benefit of U.S. Provisional Patent Application No. 62/318,880, filed on Apr. 6, 2016, and entitled “Apprentice Scheduler,” the entirety of which is incorporated by reference.

### TECHNICAL FIELD

This description relates generally to task scheduling and, more particularly, to systems and methods for computationally capturing domain expert heuristics through a pairwise ranking formulation to provide human-machine collaborative scheduling policies.

### BACKGROUND INFORMATION

Resource scheduling and optimization is a costly, challenging problem that affects almost every aspect of our lives. Yet, the problem of optimal task allocation and sequencing with upper- and lower-bound temporal constraints (i.e., deadlines and wait constraints) is NP-Hard, and real-world scheduling problems quickly become computationally intractable. However, human domain experts are able to learn from experience to develop strategies, heuristics and rules-of-thumb to effectively respond to these problems.

Researchers have made progress toward capturing domain-expert knowledge from demonstration. In one recent work, an AI scheduling assistant, called PTIME, learned how users prefer to schedule events. PTIME was subsequently able to propose scheduling changes when new events occurred by solving an integer program. Two limitations to this work exist: PTIME requires users to explicitly rank their preferences about scheduling options to initialize the system, and also uses a complete solver that, in the worst-case scenario, must consider an exponential number of options.

Research focused on capturing domain knowledge based solely on user demonstration has led to the development of inverse reinforcement learning (IRL). IRL serves the dual purpose of learning an unknown reward function for a given problem and learning a policy to optimize that reward function. However, there are two primary drawbacks to IRL for scheduling problems: computational tractability and the need for an environment model.

The classical apprenticeship learning algorithm developed in 2004 requires repeated solving of a Markov decision process (MDP) until a convergence criterion is satisfied. However, enumerating a large state-space, such as that found in large-scale scheduling problems involving hundreds of tasks and tens of agents, can quickly become computationally intractable due to memory limitations. Approximate dynamic programming approaches exist that essentially reformulate the problem as a regression, but the amount of data required to regress over a large state space remains challenging, and MDP-based scheduling solutions exist only for simple problems.

IRL also requires a model of the environment for training. At its most basic, reinforcement learning uses a Markovian transition matrix that describes the probability of transitioning from an initial state to a subsequent state when taking a given action. In order to address circumstances in which environmental dynamics are unknown or difficult to model within the constraints of a transition, researchers have developed Q-Learning and its variants. However, these approaches require the ability to “practice,” or explore the state-space by querying a black-box emulator to solicit information about how taking a given action in a specific state will change that state.

What is needed, then, is an approach that utilizes domain-expert demonstrations without the need to train using an environment emulator, or explicitly model a reward function and rely upon dynamic programming or constraint solvers, which become computationally intractable for large-scale problems of interest.

### SUMMARY

Coordinating agents to complete a set of tasks with intercoupled temporal and resource constraints is computationally challenging, yet human domain experts can solve these difficult scheduling problems using paradigms learned through years of apprenticeship. A process for manually codifying this domain knowledge within a computational framework is necessary to scale beyond the “single-expert, single-trainee” apprenticeship model. However, human domain experts often have difficulty describing their decision-making processes, causing the codification of this knowledge to become laborious. Herein we describe a technique, which we call “apprenticeship scheduling,” to capture this domain knowledge in the form of a scheduling policy. Our objective is to learn scheduling policies through expert demonstration and validate that schedules produced by these policies are of comparable quality to those generated by human or synthetic experts.

We describe a new approach for capturing domain-expert heuristics through a pairwise ranking formulation. Our approach is model-free and does not require enumerating or iterating through a large state-space. We empirically demonstrate that this approach accurately learns multifaceted heuristics on a synthetic data set incorporating job-shop scheduling and vehicle routing problems, as well as on real-world data sets. We also demonstrate that policies learned from human scheduling demonstration via apprenticeship learning can substantially improve the efficiency of a branch-and-bound search for an optimal schedule by a computing device. Our research has shown that this human-machine collaborative optimization technique can be employed on real-world problems to generate solutions substantially superior to those produced by human domain experts at rates faster than an optimization approach, and can be applied to optimally solve problems more complex than those solved by a human demonstrator.

In one aspect, a method for task scheduling using domain expert heuristics captured within a computational framework is performed on at least one computer having a memory and a processor executing instructions stored in the memory. The method includes training one or more classifiers to predict (i) whether a first action should be scheduled instead of a second action using pairwise comparisons between actions scheduled by a demonstrator at particular times and actions not scheduled by the demonstrator at the particular times, and (ii) whether a particular action should be scheduled for a particular agent at a particular time. The method also includes generating a schedule for a set of actions to be performed by a plurality of agents using a plurality of resources over a plurality of time steps. Generating the schedule includes using the one or more classifiers to determine (i) a highest priority action in the set of actions, and (ii) whether the highest priority action should be scheduled for a particular agent at a particular time step. Other aspects of the foregoing include corresponding systems and computer-readable media.

In one implementation, training the one or more classifiers further includes receiving a set of observations occurring over a plurality of times for a training action set. Each observation includes (i) features describing a state of each action in the training action set at one of the times and (ii) information identifying an action in the training action set scheduled at that time by a demonstrator, if any. The one or more classifiers are trained based at least in part on the observations.

In another implementation, training the one or more classifiers further includes transforming each observation into a set of new observations by performing pairwise comparisons between the action scheduled by the demonstrator at that time and other actions not scheduled by the demonstrator at that time. Performing the pairwise comparisons can include creating a positive example for each observation in which an action was scheduled by computing a difference between corresponding values in a first feature vector describing a scheduled action in that observation and a second feature vector describing an unscheduled action in that observation. Performing the pairwise comparisons can also include creating a negative example for each observation in which an action was not scheduled by computing a difference between corresponding values in a first feature vector describing an unscheduled action in that observation and a second feature vector describing a scheduled action in that observation.

Further implementations of these aspects can include one or more of the following features. The one or more classifiers can be trained using positive examples from observations in a set of observations in which an action was scheduled and negative examples from observations in a set of observations in which no action was scheduled. The resources can include resources shared among the agents. Each action in the set of actions can include a task, an agent, and a resource. Each action in the set of actions can include one or more scheduling-relevant features including deadline, earliest time available, precedence, duration, resource required, and dependence on other action. The plurality of agents can be configured to perform the set of actions according to the schedule.

Other aspects and advantages of the invention will become apparent from the following drawings, detailed description, and claims, all of which illustrate the principles of the invention by way of example only.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, emphasis instead generally being placed upon illustrating the principles of the invention.

FIG. 1 depicts an example high-level architecture of a system for generating task schedules for a plurality of agents.

FIG. 2 depicts a flow diagram of a method for apprentice scheduling according to an implementation.

FIG. 3 depicts example pseudocode for an apprentice scheduling algorithm.

FIGS. 4A and 4B depict the sensitivity and specificity of various machine learning techniques.

FIGS. 5A and 5B depict the sensitivity and specificity of a pairwise decision tree.

FIGS. 6A and 6B depict the sensitivity and specificity for a pairwise decision tree tuned for leafiness, with a corresponding data set comprising schedules with homogeneous agents.

FIGS. 7A and 7B depict the sensitivity and specificity for a pairwise decision tree tuned for leafiness, with a corresponding data set comprising schedules with heterogeneous agents.

FIG. 8 depicts an example architecture for a Collaborative Optimization via Apprenticeship Scheduling system.

### DETAILED DESCRIPTION

### 1 Introduction

Described herein, in various implementations, is a technique termed “apprenticeship scheduling,” which aims to capture domain-expert knowledge in the form of a scheduling policy. Our objective is to learn scheduling policies through expert demonstration and validate that schedules produced by these policies are of comparable quality to those generated by human or synthetic experts. Our approach efficiently utilizes domain-expert demonstrations without the need to train using an environment emulator. Rather than explicitly modeling a reward function and relying upon dynamic programming or constraint solvers, which become computationally intractable for large-scale problems of interest, our objective is to use action-driven learning to extract the strategies of domain experts in order to efficiently schedule tasks.

The technique incorporates the use of pairwise comparisons between the actions taken (e.g., schedule agent a to complete task τᵢ at time t) and the set of actions not taken (e.g., unscheduled tasks at time t) to learn the relevant model parameters and scheduling policies demonstrated by the training examples. Results from prior work have indicated that expert demonstrators are not readily able to describe the policies they use to make scheduling decisions; we can, however, solicit the features the experts reason about. Thus, by using pairwise comparisons of the features describing the action taken at each moment in time relative to the corresponding set of actions not taken, we can construct a classifier able to predict the rank of all possible actions and, in turn, predict which action the expert would ultimately take at each moment in time. We validate our approach using both a synthetic data set of solutions for a variety of scheduling problems and a real-world data set of demonstrations from human experts solving a hospital resource allocation problem.

The first problem we considered was a vehicle routing problem with time windows, temporal dependencies and resource constraints. Depending upon parameter selection, this family of problems encompasses the traveling salesman, job-shop scheduling, multi-vehicle routing and multi-robot task allocation problems, among others. We found that apprenticeship scheduling accurately learns multifaceted heuristics that emulate the demonstrations of experts solving these problems. We tested the robustness of the approach by generating a “noisy” synthetic expert that chooses an incorrect action 20% of the time. We observed that an apprenticeship scheduler trained on a small data set of 15 scheduling demonstrations selected the correct scheduling action with up to 95% accuracy. Next, we trained a decision support tool to assist nurses in managing resources including patient rooms, staff and equipment in a Boston hospital. We found that 90% of the high-quality recommendations generated by the apprentice scheduler were accepted by the nurses and doctors participating in the study.

In this disclosure, we also introduce a new technique called Collaborative Optimization via Apprenticeship Scheduling (COVAS), which incorporates learning from human expert demonstration within an optimization framework to automatically and efficiently produce optimal solutions for challenging real-world scheduling problems. This technique applies apprenticeship scheduling to generate a favorable (if suboptimal) initial solution to a new scheduling problem. To guarantee that the generated schedule is serviceable, we augment the apprenticeship scheduler to solve a constraint satisfaction problem, ensuring that the execution of each scheduling commitment does not directly result in infeasibility for the new problem. COVAS uses this initial solution to provide a tight bound on the value of the optimal solution, substantially improving the efficiency of a branch-and-bound search for an optimal schedule. We show here that COVAS is able to leverage viable (but imperfect) human demonstrations to quickly produce globally optimal solutions. We further show that COVAS can transfer an apprenticeship scheduling policy learned for a small problem to optimally solve problems involving twice as many variables as those observed during any training demonstrations, and also produce an optimal solution an order of magnitude faster than mathematical optimization alone.

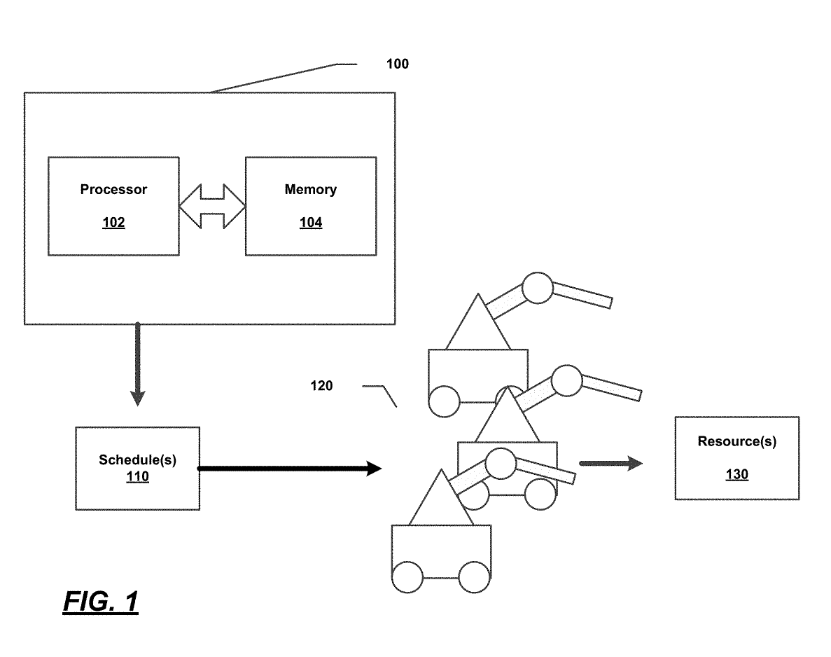

Referring to FIG. 1, the disclosed techniques can be implemented on at least one computing device in the form of a computer 100 that includes a processing unit 102, a memory 104, and a system bus that couples various system components including the memory 104 to the processing unit 102. The computer 100 can be configured to perform the processes described herein to learn scheduling policies through scheduling demonstration by one or more demonstrators and generate schedules 110 based on these policies. The generated schedules 110 can be used to program one or more agents 120, such as robots, vehicles, and various forms of computing devices, to perform tasks according to the schedules 110 on one or more resources 130 that can, in some instances, be shared among one or more of the agents 120. In some implementations, the agents include human actors, alone or in combination with synthetic actors, who can act in accordance with a schedule produced by the present system.

### 2 Model for Apprenticeship Learning

In this section, we present a framework for learning, via expert demonstration, a scheduling policy that correctly determines which task to schedule as a function of task state.

### 2.1 Problem Domain

In various embodiments, our apprenticeship learning model addresses a variety of scheduling problem types. In “A Comprehensive Taxonomy for Multi-Robot Task Allocation,” IJRR, 32(12), 1495-512 (2013), incorporated by reference in its entirety, Korsah et al. provided a comprehensive taxonomy for classes of scheduling problems, which vary according to formulation of constraints, variables and objective or utility function. Within this taxonomy, there are four classes addressing interrelated utilities and constraints: No Dependencies (ND), In-Schedule Dependencies (ID), Cross-Schedule Dependencies (XD) and Complex Dependencies (CD).

The Korsah et al. taxonomy also delineates between tasks requiring one agent (“single-agent tasks” (SA)); and tasks requiring multiple agents (“multi-agent tasks” (MA)). Similarly, agents that perform one task at a time are “single-task agents” (ST), while agents capable of performing multiple tasks simultaneously are “multi-task agents” (MT). Lastly, the taxonomy distinguishes between “instantaneous assignment” (IA), in which all task and schedule commitments are made immediately, and “time-extended assignment” (TA), in which current and future commitments are planned.

Herein, we demonstrate our approach for two of the most difficult classes of scheduling problems defined within this taxonomy: XD [ST-SA-TA] and CD [MT-MA-TA]. The first problem we consider is the vehicle routing problem with time windows, temporal dependencies and resource constraints (VRPTW-TDR), which is an XD [ST-SA-TA]-class problem. Depending on parameter selection, this family of problems encompasses the traveling salesman, job-shop scheduling, multi-vehicle routing and multi-robot task allocation problems, among others. In this domain, agents are assigned to complete a set of tasks. These tasks are related through precedence or wait constraints, as well as deadline constraints, which could be absolute (relative to the start of the schedule) or relative to another task's initiation or completion time. Agents are required to access a set of shared resources, such as the task's physical location, to execute each task. Agents and tasks have defined starting locations, and task locations are static. Agents are only able to perform tasks when present at the corresponding task location, and each agent is assumed to travel between task locations at a constant speed. Task completion times are non-uniform and agent-specific, as would be the case for heterogeneous agents. An agent that is incapable of performing a task is assumed to have an infinite completion time for that task. The objective is to minimize the makespan for completing all tasks.

We next consider a real-world problem within the more-difficult CD [MT-MA-TA] class. The problem is one of hospital resource allocation on a labor and delivery unit, wherein one nurse, called the “resource nurse,” is responsible for ensuring that the correct patient is in the correct type of room at the correct time, with the correct types of nurses present to care for those patients. The functions of a resource nurse are to assign nurses to take care of labor patients; assign patients to labor beds, recovery room beds, operating rooms, antepartum ward beds or postpartum ward beds; assign scrub technicians to assist with surgeries in operating rooms; call in additional nurses if necessary; accelerate, delay or cancel scheduled inductions or cesarean sections; expedite active management of a patient in labor; and reassign roles among nurses.

### 2.2 Technical Approach

Many approaches to learning via demonstration, such as reinforcement or inverse reinforcement learning, are based on Markov models. Markov models, however, do not capture the temporal dependencies between states and are computationally intractable for large problem sizes. To counter this, we present a pairwise formulation to model the problem of predicting the best task to schedule at time t. The pairwise model has key advantages over a listwise approach: First, classification algorithms (e.g., support vector machines) can be directly applied. Second, a pairwise approach is non-parametric, in that the cardinality of the input vector is not dependent upon the number of tasks (or actions) that can be performed at any instance. Third, training examples of pairwise comparisons in the data can be readily solicited. From a given observation during which a task was scheduled, we only know which task was most important, not the relative importance between all tasks. Thus, we create training examples based on pairwise comparisons between scheduled and unscheduled tasks. A pairwise approach is more natural because we lack the necessary context to determine the relative rank between two unscheduled tasks.

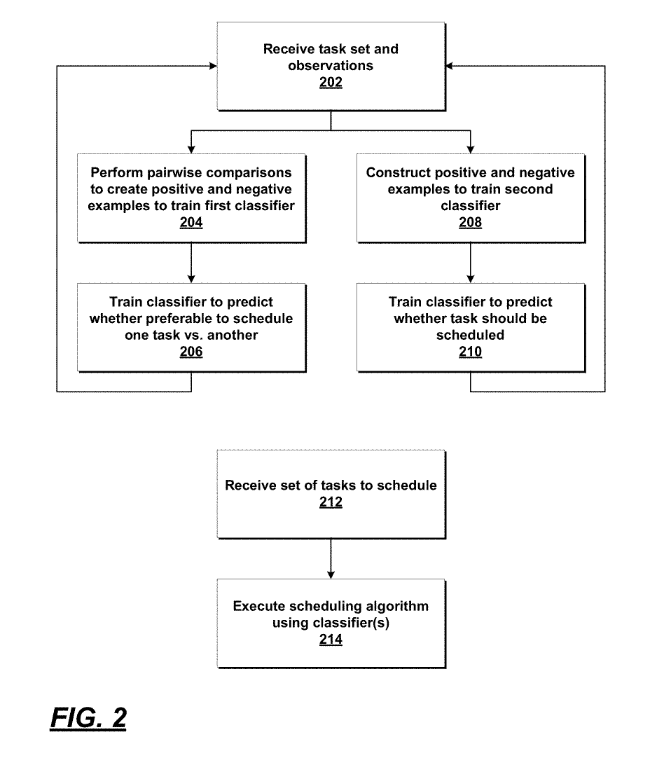

FIG. 2 depicts a flow diagram of an example method for apprentice scheduling of actions, where each action is composed of a task, an agent, and a resource. Further, each action can have an associated feature vector describing how the state would change if that action were taken. In STEP 202, a set of tasks and associated observations is received by the system. Consider, in one implementation, a set of tasks, τᵢ∈τ, in which each task has a set of real-valued features, γ_{τ}_{ᵢ}. Each scheduling-relevant feature γ_{τ}_{ᵢ}^{j} may represent, for example, the deadline, the earliest time the task is available, the duration of the task, which resource r is required by this task, etc.

Next, consider a set of m observations, O={O₁, O₂, . . . , Oₘ}. Observation Oₘ includes a feature vector {γ_{τ}_{₁}, γ_{τ}_{₂}, . . . , γ_{τ}_{ₙ}} describing the state of each task, the task scheduled by the expert demonstrator (including a null task, τ, if no task was scheduled), and the time at which an action was taken. The goal is to learn a policy that correctly determines which task to schedule as a function of the task state.

We deconstruct the problem into two steps: 1) for each agent/resource pair, determine the candidate next task to schedule; and 2) for each task, determine whether to schedule the task from the current state. In order to learn to correctly assign the next task to schedule, we transform, in STEP 204, each observation Oₘ into a new set of observations by performing pairwise comparisons between the scheduled task τᵢ and the set of unscheduled tasks (Equations 1-2). Equation 1 creates a positive example for each observation in which a task τᵢ was scheduled. This example consists of the input feature vector, [symbol] and a positive label, [symbol] =1. Each element of input feature vector [symbol] is computed as the difference between the corresponding values in the feature vectors γ_{τ}_{ᵢ} and γ_{τ}_{ₓ}, describing scheduled task τᵢ and unscheduled task τₓ. Equation 2 creates a set of negative examples with [symbol] =0. For the input vector, we take the difference of the feature values between unscheduled task τₓ and scheduled task τᵢ.

This feature set can then be augmented to capture additional contextual information important for scheduling, which may not be captured in examples consisting solely of differences between task features. For example, a scheduling policy may change based on progress toward task completion; i.e., the proportion of tasks completed so far. To provide this high-level information, we include ξ_{τ}, the set of contextual, high-level features describing the set of tasks for observation Oₘ, in (Equations 1-2).

In one implementation, our technique depends on the ability of domain experts to articulate an appropriate set of features for the given problem. Results from prior work have indicated that domain experts are adept at describing the high-level, contextual, and task-specific features used in their decision making; however, it is more difficult for experts to describe how they reason about these features. Other implementations can use feature learning rather than relying upon experts to enumerate the important features they reason about in order to construct schedules.

In STEP 206, given these observations Oₘ and their associated features, we can train a classifier, f_{priority}(τᵢ,τₓ)∈{0,1}, to predict whether it is more preferable (e.g., whether it will create a better outcome) to schedule task τᵢ as the next task rather than τₓ. With this pairwise classifier, we can determine which single task τᵢ is the highest-priority task τᵢ* according to Equation 3 by determining which task has the highest cumulative priority in comparison to the other tasks in τ. In some implementations, the classifier is trained on additional task sets and observations (i.e., the method returns to STEP 202).

We train a single classifier, f_{priority}(τᵢ, τⱼ), to model the behavior of the set of all agents rather than train one f_{priority} (τᵢ, τⱼ) for each agent. f_{priority}(τᵢ, τⱼ) is a function of all features associated with the agents; as such, agents need not be interchangeable, and different sets of features may be associated with each agent.

Next, we must learn to predict whether τᵢ* should be scheduled or the agent should remain idle. To do so, in STEP 210, we train a second classifier, f_{act}(τᵢ)∈{0,1}, that predicts whether or not τᵢ should be scheduled. The observations set, O, consists either of examples in which a task was scheduled or those in which no task was scheduled. To train this classifier, we construct a new set of examples according to Equation 4, which assigns positive labels to examples from Oₘ in which a task was scheduled and negative labels to examples in which no task was scheduled (STEP 208). The second classifier can be trained on additional task sets and observations (i.e., the method returns to STEP 202).

In some implementations, a single classifier can be used instead of the two above described classifiers. In this instance, the single classifier can be trained to determine both which action to perform, as well as whether that action should be performed or if the agent should remain idle.

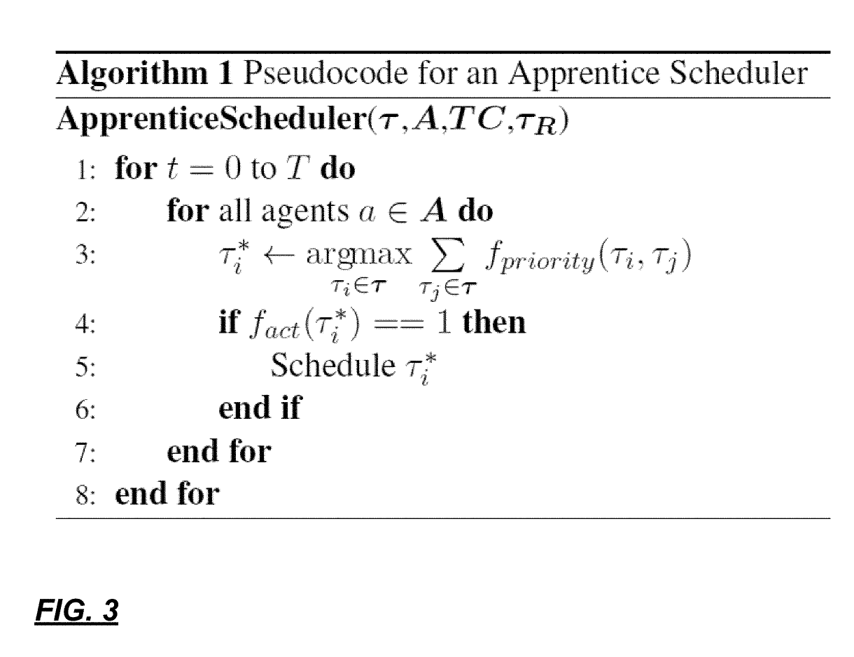

Finally, we construct a scheduling algorithm to act as an apprentice scheduler. FIG. 3 depicts example pseudocode representing this scheduling algorithm. In STEP 212 of FIG. 2, this algorithm takes as input the set of tasks, τ; agents, A; temporal constraints (i.e., upper- and lowerbound temporal constraints) relating tasks in the problem, TC; and the set of task pairs that require the same resources and can therefore not be executed at the same time, τ_{R}. In STEP 214, the scheduling algorithm is executed using the two classifiers in order to generate a schedule. As shown in FIG. 3, lines 1-2 iterate over each agent at each time step. In Line 3, the highest-priority task, τᵢ*, is determined for a particular agent. In Lines 4-5, τᵢ* is scheduled if f_{act} (τᵢ*) predicts that τᵢ* should be scheduled at the current time.

Note that iteration over agents (Line 2) can be performed according to a specific ordering, or the system can alternatively learn a more general priority function to select and schedule the best agent-task-resource tuple using f_{priority}( [symbol] τᵢ, a, r [symbol] , [symbol] τⱼ, a′, r′ [symbol] ), f_{act}( [symbol] τᵢ, a, r [symbol] *). In the latter case, the features γ_{τ}_{ᵢ} are mapped to agent-task-resource tuples rather than tasks τᵢ, which represent the atomic (i.e., lowest-level) job. For the synthetic evaluation, we use the original formulation, f_{priority} (τᵢ, τⱼ) For the TAG application, we use f_{priority}( [symbol] τᵢ^{t}, a, r [symbol] , [symbol] τⱼ^{t}, a′, r′ [symbol] ), where τᵢ^{t} represents the objective of mitigating opposing game piece i during time step t, a is the decoy to be deployed, and r is the physical location for that deployment. For the hospital domain evaluation, we use f_{priority}( [symbol] τᵢ^{j}, a, r [symbol] , [symbol] τₚ^{q}, a′, r′ [symbol] ) where τᵢ^{j} represents the j^{th} stage of, labor for patient i, a is the assigned nurse, and r is the room to which the patient is assigned. For convenience in notation, we refer to this tuple as a “scheduling action.”

Our model is a hybrid point- and pairwise formulation, which has several key benefits for learning to schedule form expert demonstration. First, we can directly apply standard classification techniques, such as a decision tree, support vector machine, logistic regression, or neural networks. Second, because this technique only considers two scheduling actions at a time, the model is non-parametric in the number of possible actions. Thus, the system can train on f_{priority}(τᵢ, τⱼ) schedules with a agents and n tasks, yet apply f_{priority}(τᵢ, τⱼ) to construct a schedule for a problem with a′ agents and n′ tasks where a≠a′, n≠n′, and a*n≠a′*n′. Furthermore, it can even train f_{priority}(τᵢ, τⱼ) on demonstrations of a heterogeneous data set of scheduling observations with differing numbers of agents and tasks. Third, the pairwise portion of the formulation provides structure for the learning problem. A formulation that simply concatenated the features of two or more scheduling actions would need to solve the more complex problem of learning the relationships between features and then how to use those relationships to predict the highest-priority scheduling action. Such a concatenation approach would suffer from the curse of dimensionality and require a very large training data set. Note, however, that this method requires the designer to appropriately partition the features into pairwise and pointwise components such that the pairwise portion does not lose information by considering the differences between actions' features. Fourth, the transformation of the observations into a pairwise model results in some features that are advantageous for learning from small data sets: the number of positive and negative training examples is balanced given that the algorithm simultaneously creates one negative label for every positive label, and the observations are bootstrapped to create 2*|τ| examples for each time step, rather than only |τ| for a pointwise model.

$$\begin{matrix}{}_{ }^{rank}{θ}{}_{〈 {τ}_{i} , {τ}_{j} 〉}^{m} \text{:=} [ {ξ}_{τ} , {γ}_{{τ}_{i}} - {γ}_{{τ}_{j}} ] , {y}_{〈 {τ}_{i} , {τ}_{j} 〉}^{m} = 1 , ∀ {τ}_{j} ∈ τ \backslash {τ}_{i} , ∀ {O}_{m} ∈ O \vert {τ}_{i} scheduled in {O}_{m} & ( 1 ) \\ {}_{ }^{rank}{θ}{}_{〈 {τ}_{j} , {τ}_{j} 〉}^{m} \text{:=} [ {ξ}_{τ} , {γ}_{{τ}_{j}} - {γ}_{{τ}_{i}} ] , {y}_{〈 {τ}_{j} , {τ}_{i} 〉}^{m} = 0 , ∀ {τ}_{j} ∈ τ \backslash {τ}_{i} , ∀ {O}_{m} ∈ O \vert {τ}_{i} scheduled in {O}_{m} & ( 2 ) \\ \hat{{τ}_{l}^{*}} = {argmax}_{{τ}_{i} ∈ τ} {\sum }_{{τ}_{j} ∈ τ} {f}_{priority} ( {τ}_{i} , {τ}_{j} ) & ( 3 ) \\ {}_{ }^{act}{φ}{}_{{τ}_{i}}^{m} \text{:=} [ {ξ}_{τ} , {γ}_{{τ}_{i}} ] , {y}_{{τ}_{i}}^{m} = \{ \begin{matrix}1 \text{:} {τ}_{i} scheduled in {O}_{m} ⋀ {τ}_{i} scheduled in {O}_{m + 1} \\ 0 \text{:} {τ}_{∅} scheduled in {O}_{m} \end{matrix} & ( 4 )\end{matrix}$$

### 3 Data Sets

Here, we validate that schedules produced by the learned policies are of comparable quality to those generated by human or synthetic experts. To do so, we considered a synthetic data set from the XD [ST-SA-TA] class of problems and a real-world data set from the CD [MT-MA-TA] class of problems, as defined by Korsah et al. We present each problem domain and describe the manner in which the data set of expert demonstrations for the domain was acquired.

### 3.1 Synthetic Data Set

For our first investigation, we generated a synthetic data set of scheduling problems in which agents were assigned a set of tasks. The tasks were related through precedence or wait constraints, as well as deadline constraints, which could be absolute (relative to the start of the schedule) or relative to another task's initiation or completion time. Agents were required to access a set of shared resources to execute each task. Agents and tasks had defined starting locations, and task locations were static. Agents were only able to perform tasks when present at the corresponding task location, and each agent traveled at a constant speed between task locations. Task completion times were potentially non-uniform and agent-specific, as would be the case for heterogeneous agents. An agent that was incapable of performing a given task was assumed to have an infinite completion time for that task. The objective was to minimize the makespan or other time-based performance measures.

This problem definition spans a range of scheduling problems, including the traveling salesman, job-shop scheduling, multi-vehicle routing and multi-robot task allocation problems, among others. We describe this range as a vehicle routing problem with time windows, temporal dependencies, and resource constraints (VRPTW-TDR), which falls within the XD [ST-SA-TA] class in the taxonomy by Korsah et al.: agents perform tasks sequentially (ST), each task requires one agent (SA), and commitments are made over time (TA).

To generate our synthetic data set, we developed a mock scheduling expert that applies one of a set of context-dependent rules based on the composition of the given scheduling problem. This behavior was based upon rules presented in prior work addressing these types of problems. Our objective was to show that our apprenticeship scheduling algorithm learns both context-dependent rules and how to identify the associated context for their correct application.

The mock scheduling expert functions as follows: First, the algorithm collects all alive and enabled tasks τᵢ∈τ_{AE} as defined by Muscettola, Morris, & Tsamardinos in “Reformulating Temporal Plans for Efficient Execution,” Proc. KR&R, Trento, Italy (1998), which is incorporated herein by reference in its entirety. Consider a pair of tasks, τᵢ and τⱼ, with start and finish times sᵢ,fᵢ and sᵢ,fᵢ, respectively, such that there is a wait constraint requiring τᵢ to start at least [symbol] units of time after τⱼ. A task τᵢ is alive and enabled if t≧fⱼ+W_{τ}_{ⱼ}_{,τ}_{ᵢ} for all such τⱼ and [symbol] in τ.

After task collection, the heuristic iterates over each agent to identify the highest-priority task, τᵢ*, to schedule for that agent. The algorithm determines which scheduling rule is most appropriate to apply for each agent. If agent speed is sufficiently slow (≦1 m/s), travel time will become the major bottleneck. If agents move quickly but utilize one or more resources R heavily

$$( {Σ}_{{τ}_{i}} {Σ}_{{τ}_{j}} {1}_{{R}_{{τ}_{i}} = {R}_{{τ}_{j}}} \geq c for some constant c ) ,$$

use of these resources can become the bottleneck. Otherwise, task durations and associated wait constraints are generally most important.

If the algorithm identifies travel distance as the primary bottleneck, it chooses the next task by applying a priority rule well-suited for vehicle routing that minimizes a weighted, linear combination of features comprised of the distance and angle relative to the origin between agent a and τⱼ. This rule is depicted in Equation 5, where \vec{l}ₓ is the location of τⱼ, \vec{l}ₐ is the location of agent a, θₓₐ is the relative angle between the vector from origin to the agent location and the origin to the location of τⱼ, and α₁ and α₂ are weighting constants:

$${τ}_{i}^{*} ← {argmin}_{{τ}_{j} ∈ {τ}_{AE}} ( \vert \vert {\vec{l}}_{x} - {\vec{l}}_{a} \vert \vert + {α}_{1} {θ}_{xa} + {α}_{2} \vert \vert {\vec{l}}_{x} - {\vec{l}}_{a} \vert \vert {θ}_{xa} ) \qquad ( 5 )$$

If the algorithm identifies resource contention as the most important bottleneck, it employs a rule to mitigate resource contention in multi-robot, multi-resource problems based on prior work in scheduling for multi-robot teams. Specifically, the algorithm uses Equation 6 to select the high-priority task to schedule next, where d_{τ}_{ᵢ} is the deadline of τⱼ and α₃ is a weighting constant:

$${τ}_{i}^{*} ← {argmax }_{{τ}_{j} ∈ {τ}_{AE}} ( ( {\sum }_{{τ}_{i}} {\sum }_{{τ}_{j}} {1}_{{R}_{{τ}_{i}} = {R}_{{τ}_{j}}} ) - {α}_{3} {d}_{{τ}_{j}} ) \qquad ( 6 )$$

If the algorithm decides that temporal requirements are the major bottleneck, it employs an Earliest Deadline First rule (Equation 7), which performs well across many scheduling domains:

$${τ}_{i}^{*} ← {argmax}_{{τ}_{j} ∈ {τ}_{AE}} {d}_{{τ}_{j}} \qquad ( 7 )$$

After selecting the most important task, τᵢ*, the algorithm determines whether the resource required for τᵢ*, R_{τ}_{ᵢ}_{^{*}}, is idle and whether the agent is able to travel to the task location by time t. If these constraints are satisfied, the heuristic schedules task τᵢ* at time t. (An agent is able to reach task τᵢ* if t≧fⱼ+k(lᵢ−lⱼ)/∥lᵢ−lⱼ∥ for all τⱼ∈τ that the agent has already completed, where k is the agent's speed.)

We constructed the synthetic data set for two homogeneous agents and 20 partially ordered tasks located within a 20×20 grid.

### 3.2 Real-World Data Set: Labor and Delivery

To further evaluate our approach, we applied our method to a data set collected from a labor and delivery floor at a Boston hospital. In this domain, a resource nurse must solve a problem of task allocation and schedule optimization with stochasticity in the number and types of patients and the duration of tasks.

Using our apprenticeship scheduling method in this context, a task τᵢ represents the set of steps (subtasks) required to care for patient i, and each τᵢ^{j} is a given stage of labor for that patient. Stages of labor are related by stochastic lowerbound constraints [symbol] , requiring the stages to progress sequentially. There are stochastic time constraints, D_{τ}_{ᵢ}_{^{j}}^{abs} and [symbol] , relating the stages of labor to account for the inability of resource nurses to perfectly control when a patient will move from one stage to the next. Arrivals of τᵢ (i.e., patients) are drawn from stochastic distributions. The model considers three types of patients: scheduled cesarean patients, scheduled induction patients and unscheduled patients. The set of [symbol] , D_{τ}_{ᵢ}_{^{j}}^{abs} and [symbol] are dependent upon patient type.

Labor nurses are modeled as agents with a finite capacity to process tasks in parallel, where each subtask requires a variable amount of this capacity. For example, a labor nurse may generally care for a maximum of two patients simultaneously. If the nurse is caring for a patient who is “full and pushing” (i.e., the cervix is fully dilated and the patient is actively trying to push out the baby) or in the operating room, he or she may only care for that patient.

Rooms on the labor floor (e.g., a labor room, an operating room, etc.) are modeled as resources, which process subtasks in series. Agent and resource assignments to subtasks are pre-emptable, meaning that the agent and resource assigned to care for any patient during any step in the care process may be changed over the course of executing that subtask.

In this formulation, ^{t}A_{τ}_{ᵢ}_{^{j}}^{a}∈{0,1} is a binary decision variable for assigning agent a to subtask τᵢ^{j} for time epoch [t, t+1). ^{t}G_{τ}_{ⱼ}_{^{j}}^{a} is an integer decision variable for assigning a certain portion of the effort of agent a to subtask τᵢ^{j} for time epoch [t, t+1).

$${}_{ }^{t}{R}{}_{{τ}_{i}^{j}}^{r} ∈ \{ 0 , 1 \}$$

is a binary decision variable for whether subtask τᵢ^{j} is assigned resource r for time epoch [t, t+1). H_{τ}_{ᵢ}∈{0,1} is a binary decision variable for whether task τᵢ and its corresponding subtasks are to be completed. U_{τ}_{ᵢ}_{^{j}}; specifies the effort required from any agent to work on τᵢ^{j}. s_{τ}_{ᵢ}_{^{j}}, f_{τ}_{ᵢ}_{^{j}}∈[0, ∞) are the start and finish times of τᵢ^{j}.

$$\begin{matrix}min fn ( \{ {}_{ }^{t}{A}{}_{{τ}_{i}^{j}}^{a} \} , \{ {}_{ }^{t}{G}{}_{{τ}_{i}^{j}}^{a} \} , \{ * {}_{ }^{t}{R}{}_{{τ}_{i}^{j}}^{r} \} , \{ {H}_{{τ}_{i}} \} , \{ {s}_{{τ}_{i}^{j}} , {f}_{{τ}_{i}^{j}} \} ) & ( 8 ) \\ {\sum }_{a ∈ A} {}_{ }^{t}{A}{}_{{τ}_{i}^{j}}^{a} \geq 1 - M ( 1 - {H}_{{τ}_{i}} ) , ∀ {τ}_{i}^{j} ∈ τ , ∀ t & ( 9 ) \\ M ( 2 - {}_{ }^{t}{A}{}_{{τ}_{i}^{j}}^{a} - {H}_{{τ}_{i}} ) \geq - {U}_{{τ}_{i}^{j}} + {}_{ }^{t}{G}{}_{{τ}_{i}^{j}}^{a} \geq M ( {}_{ }^{t}{A}{}_{{τ}_{i}^{j}}^{a} + {H}_{{τ}_{i}} - 2 ) , ∀ {τ}_{i}^{j} ∈ τ , ∀ t & ( 10 ) \\ {\sum }_{{τ}_{i}^{j} ∈ τ} {}_{ }^{t}{G}{}_{{τ}_{i}^{j}}^{a} \leq {C}_{a} , ∀ a ∈ A , ∀ t & ( 11 ) \\ {\sum }_{r ∈ R} {}_{ }^{t}{R}{}_{{τ}_{i}^{j}}^{r} \geq 1 - M ( 1 - {H}_{{τ}_{i}} ) , ∀ {τ}_{i}^{j} ∈ τ , ∀ t & ( 12 ) \\ {\sum }_{{τ}_{i}^{j} ∈ τ} {}_{ }^{t}{R}{}_{{τ}_{i}^{j}}^{r} \leq 1 , ∀ r ∈ R , ∀ t & ( 13 ) \\ {ub}_{{τ}_{i}^{j}} \geq {f}_{{τ}_{i}^{j}} - {s}_{{τ}_{i}^{j}} \geq {lb}_{{τ}_{i}^{j}} , ∀ {τ}_{i}^{j} ∈ τ & ( 14 ) \\ {s}_{{τ}_{x}^{y}} - {f}_{{τ}_{i}^{j}} \geq {W}_{〈 {τ}_{i} , {τ}_{j} 〉} , ∀ {τ}_{i} , {τ}_{j} ∈ τ \vert , ∀ {W}_{〈 {τ}_{i} , {τ}_{j} 〉} ∈ TC & ( 15 ) \\ {f}_{{τ}_{x}^{y}} - {s}_{{τ}_{i}^{j}} \leq {D}_{〈 {τ}_{i} , {τ}_{j} 〉}^{rel} , ∀ {τ}_{i} , {τ}_{j} ∈ τ \vert ∃ {D}_{〈 {τ}_{i} , {τ}_{j} 〉}^{rel} ∈ TC & ( 16 ) \\ {f}_{{τ}_{i}^{j}} \leq {D}_{{τ}_{i}}^{abs} , ∀ {τ}_{i} ∈ τ \vert ∃ {D}_{{τ}_{i}}^{abs} ∈ TC & ( 17 )\end{matrix}$$

Equation 9 enforces that each subtask τᵢ^{j} during each time epoch [t, t+1) is assigned a single agent. Equation 10 ensures that each subtask τᵢ^{j} receives a sufficient portion of the effort of its assigned agent a during epoch [t, t+1). Equation 11 ensures that agent a is not oversubscribed. Equation 12 ensures that each subtask τᵢ^{j} of each task τᵢ that is to be completed (i.e., H_{τ}_{ᵢ}=1) is assigned one resource r. Equation 13 ensures that each resource r is assigned to only one subtask during each epoch [t, t+1). Equation 14 requires the duration of subtask τᵢ^{j} to be less than or equal to ub_{τ}_{ᵢ}_{^{j}} and at least lb_{τ}_{ᵢ}_{^{j}}; units of time. Equation 15 requires that τₓ^{y} occurs at least [symbol] units of time after τᵢ^{j}. Equation 16 requires that the duration between the start of τᵢ^{j} and the finish of τₓ^{y} be less than [symbol] Equation 17 requires that τᵢ^{j} finishes before D_{τ}_{ᵢ}_{^{j}}^{abs} units of time have expired since the start of the schedule.

The functions of a resource nurse are to assign nurses to take care of labor patients and to assign patients to labor beds, recovery room beds, operating rooms, antepartum ward beds or postpartum ward beds. The resource nurse has substantial flexibility when assigning beds, and his or her decisions will depend upon the type of patient and the current status of the unit in question. He or she must also assign scrub technicians to assist with surgeries in operating rooms, and call in additional nurses if required. The corresponding decision variables for staff assignments and room/ward assignments in the above formulation are ^{t}A_{τ}_{ᵢ}_{^{j}}^{a} and ^{t}R_{τ}_{ᵢ}_{^{j}}^{a}, respectively.

The resource nurse may accelerate, delay or cancel scheduled inductions or cesarean sections in the event that the floor is too busy. Resource nurses may also request expedited active management of a patient in labor. The decision variables for the timing of transitions between the various steps in the care process are described by s_{τ}_{ᵢ}_{^{j}} and f_{τ}_{ᵢ}_{^{j}}. The commitments to a patient (or that patient's procedures) are represented by H_{τ}_{ᵢ}.

The resource nurse may also reassign roles among nurses: For example, a resource nurse may pull a nurse from triage, or even care for patients herself if the floor is too busy. Or, if a patient's condition is particularly acute (e.g., the patient has severe preeclampsia), the resource nurse may assign one-to-one nursing. The level of attentional resources a patient requires and the level a nurse has available correspond to variables U_{τ}_{ᵢ}_{^{j}} and ^{t}G_{τ}_{ᵢ}_{^{j}}^{a}, respectively. The resource nurse makes his or her decisions while considering current patient status Λ_{τ}_{ᵢ}_{^{j}}, which can be manually transcribed on, e.g., a whiteboard.

The stochasticity of the problem arises from the uncertainty in the upper- and lower-bound of the durations (ub_{τ}_{ᵢ}_{^{j}} and lb_{τ}_{ᵢ}_{^{j}}) of each of the steps in caring for a patient; the number and types of patients, τ; and the temporal constraints, TC, relating the start and finish of each step. These variables are a function of the resource and staff allocation variables, ^{t}R_{τ}_{ᵢ}_{^{j}}^{a} and ^{t}A_{τ}_{ᵢ}_{^{j}}^{a} as well as patient task state Λ_{τ}_{ᵢ}_{^{j}}, which includes information on patient type (e.g., presentation with scheduled induction, scheduled cesarean section, or acute unplanned anomaly), gestational age, gravida, parity, membrane status, anesthesia status, cervix status, time of last exam and the presence of any comorbidities. Formally, ({ub_{τ}_{ᵢ}_{^{j}}, lb_{τ}_{ᵢ}_{^{j}}|τᵢ^{j}∈τ},τ,TC)˜P({^{t}R_{τ}_{ᵢ}_{^{j}}^{a}, ^{t}A_{τ}_{ᵢ}_{^{j}}^{a}, Λ_{τ}_{ᵢ}_{^{j}},∀t∈[0, 1, . . . , T]}).

The computational complexity of completely searching for a solution that satisfies the constraints in Equations 35-43 is given by O(2^{|A∥R|T}^{²}Cₐ^{|A|T}), where |A| is the number of agents, with each agent possessing an integer processing capacity of Cₐ. There are n tasks τᵢ, each with mᵢ subtasks, |R| resources, and an integer-valued planning horizon of T units of time. In practice, there are ˜10 nurses (agents) who can care for up to two patients at a time (i.e., Cₐ=2,∀a∈A), 20 different rooms (resources) of varying types, 20 patients (tasks) at any one time, and a planning horizon of 12 hours or 720 minutes, yielding a worst-case complexity of ˜2^{10*20*720}^{²}2^{10*720}≧2¹⁰^{⁶}, which is computationally intractable for exact methods without the assistance of informative search heuristics.

### 3.2.1 Data Collection

To collect data from resource nurses about their decisions, a high-fidelity simulation of a labor and delivery floor was developed with an actual hospital. The effort was part of a quality-improvement project at the hospital to develop training tools and involved a rigorous, year-long design and iteration process that included workshops with nurses, physicians, and medical students to ensure the tool accurately captured the role of a resource nurse. Parameters within the simulation (e.g., patient arrivals, timelines for labor progression) were drawn from medical textbooks and papers and modified through alpha and beta testing to ensure that the simulation closely mirrored the patient population and nurse experience at our partner hospital.

We invited expert resource nurses to play this simulation in order to collect a data set for training our apprenticeship scheduling algorithm. This data set was generated by seven resource nurses working with the simulation for a total of 212 hours, simulating 60 hours of elapsed time on a real labor floor and yielding a set of more than 3,013 individual decisions.

### 4 Empirical Evaluation of Apprenticeship Scheduling

In this section, we evaluate our prototype for apprenticeship scheduling using synthetic and real-world data sets.

### 4.1 Synthetic Data Set

We trained our model using a decision tree, KNN classifier, logistic regression (logit) model, a support vector machine with a radial basis function kernel (SVM-RBF), and a neural network to learn f_{priority}(.,.) and f_{act}(.). We randomly sampled 85% of the data for training and 15% for testing.

We defined the input features as follows: The high-level feature vector of the task set, ξ_{τ}, was comprised of the agents' speed and the degree of resource contention,

$${Σ}_{{τ}_{i}} {Σ}_{{τ}_{j}} {1}_{{R}_{{τ}_{i}} = {R}_{{τ}_{j}}} .$$

The task-specific feature vector, γ_{τ}_{ᵢ}, was comprised of the task's deadline, a binary indicator for whether or not the task's precedence constraints had been satisfied, the number of other tasks sharing the given task's resource, a binary indicator for whether or not the given task's resource was available, the travel time remaining to reach the task location, the distance agent a would travel to reach τᵢ, and the angular difference between the vector describing the location of agent a and the vector describing the position of τᵢ relative to agent a.

We compared the performance of our pairwise approach with pointwise and naïve approaches. In the pointwise approach, training examples for selecting the highest-priority task were of the form ^{rank}φ_{τ}_{ᵢ}^{m}:=[ξ_{τ},γ_{τ}_{ᵢ}]. The label γ_{τ}_{ᵢ}^{m} was equal to 1 if task τᵢ was scheduled in observation m, and was 0 otherwise. In the naïve approach, examples were comprised of an input vector that concatenated the high-level features of the task set and the task-specific features of the form ^{rank}φ^{m}:=[ξ_{τ},γ_{τ}_{₁},γ_{τ}_{₂}, . . . , γ_{τ}_{ₙ}]; labels γ^{m} were given by the index of the task τᵢ scheduled in observation m.

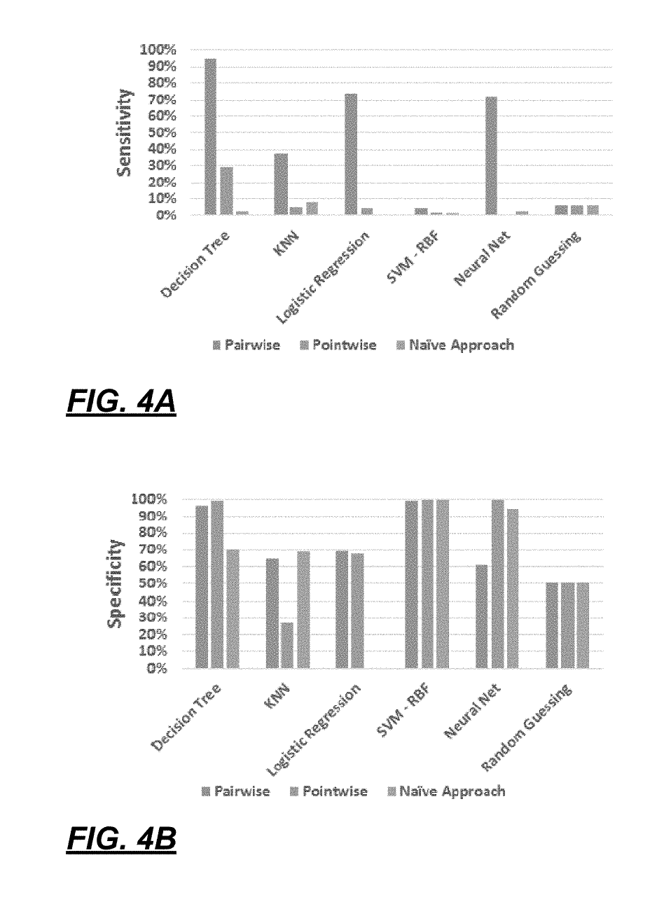

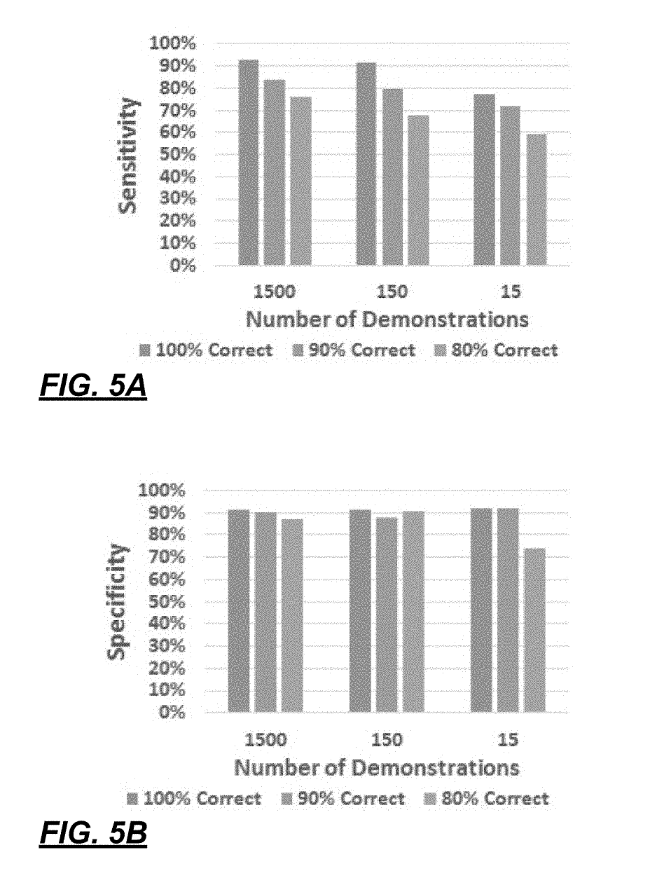

FIGS. 4A and 4B depict the sensitivity (true positive rate) and specificity (true negative rate), respectively, of machine learning techniques using the pairwise, pointwise and naïve approaches. FIGS. 5A and 5B depict the sensitivity and specificity, respectively, of the model (a pairwise decision tree), varying the number and proportion of correct demonstrations. We found that a pairwise model outperformed the pointwise and naïve approaches. Within the pairwise model, a decision tree yielded the best performance: The trained decision tree was able to identify the correct task and when to schedule that task 95% of the time, and was able to accurately predict when no task should be scheduled 96% of the time.

To more fully understand the performance of a decision tree trained with a pairwise model as a function of the number and quality of training examples, we trained decision trees with the pairwise model using 15, 150, and 1,500 demonstrations. The sensitivity and specificity depicted in FIGS. 5A and 5B for 15 and 150 demonstrations represent the mean sensitivity and specificity of 10 models trained via random sub-sampling without replacement. We also varied the quality of the training examples, assuming the demonstrator was operating under an ε-greedy approach with a (1−ε) probability of selecting the correct task to schedule, and selecting another task from a uniform distribution otherwise. This assumption is conservative; a demonstrator making an error would be more likely to pick the second- or third-best task than to select a task at random.

Training a model based on pairwise comparison between the scheduled task and unscheduled tasks effectively produced a comparable policy to that of the synthetic expert. The decision tree model performed well due to the modal nature of the multifaceted scheduling heuristic. Note that this data set consisted of scheduling strategies with mixed discrete-continuous functional components; performance could potentially be improved upon in future work by combining decision trees with logistic regression. This hybrid learning approach has been successful in prior machine learning classification tasks and can be readily applied to this apprenticeship scheduling framework. There is also an opportunity to improve performance through hyperparameter tuning (e.g., to select the minimum number of examples in each leaf of the decision tree).

Note that the results presented in FIGS. 4A-5B were achieved without any hyperparameter tuning. For example, with the decision tree, we did not perform an inner cross-validation loop to estimate the minimum number of examples in each leaf to achieve the best performance. The purpose of this analysis was to show that, with our pairwise approach, the system can accurately learn expert heuristics from example. In the following section, we investigate how apprenticeship scheduling using a decision tree classifier can be improved upon via an inner cross-validation loop to tune the model's hyperparameters.

4.1.1 Performance of Decision Tree with Hyperparameter Tuning

We performed our initial analysis, detailed above, to identify which techniques have inherent advantages that can be realized without extensive hyperparameter tuning. Our results indicate that the pairwise formulation for apprenticeship scheduling, in conjunction with a decision tree classifier, has advantages over alternative formulations for learning a high-quality scheduling policy. Given evidence of this advantage, we further evaluated the potential of the pairwise formulation with hyperparameter tuning.

To improve the performance of the model, we manipulated the “leafiness” of the decision tree to find the best setting to increase the accuracy of the apprenticeship scheduler. Specifically, we varied the minimum number of training examples required in each leaf of the tree. As the minimum number required for each leaf decreases, the chance of over-fitting to the data increases. Conversely, as the minimum number increases, the chance of not learning a helpful policy (under-fitting) increases. To identify the best number of leaves for generalization, we tested values for the minimum number of examples required for each leaf of the decision tree in the set {1,5,10,25,50,100,250,500,1000}. If the minimum number of examples in each leaf exceeded the total number of examples, the setting was trivially set to the total number of examples available for training.

We performed 5-fold cross-validation for each value of examples as follows: We trained an apprentice scheduler on four-fifths of the training data and tested on one-fifth of the data, and recorded the average testing accuracy across each of the five folds. Then, we used the setting of the minimum number of examples required for each leaf that yielded the best accuracy during cross-validation to train a full apprenticeship scheduling model on all of the training data (85% of the total data). Finally, we tested the full apprenticeship scheduling model on the 15% of the total data reserved for testing. Thus, none of the data used to test the full model was used to estimate the best setting for the leafiness of the tree. We repeated this procedure 10 times, randomly sub-sampling the data and taking the average performance across the 10 trials.

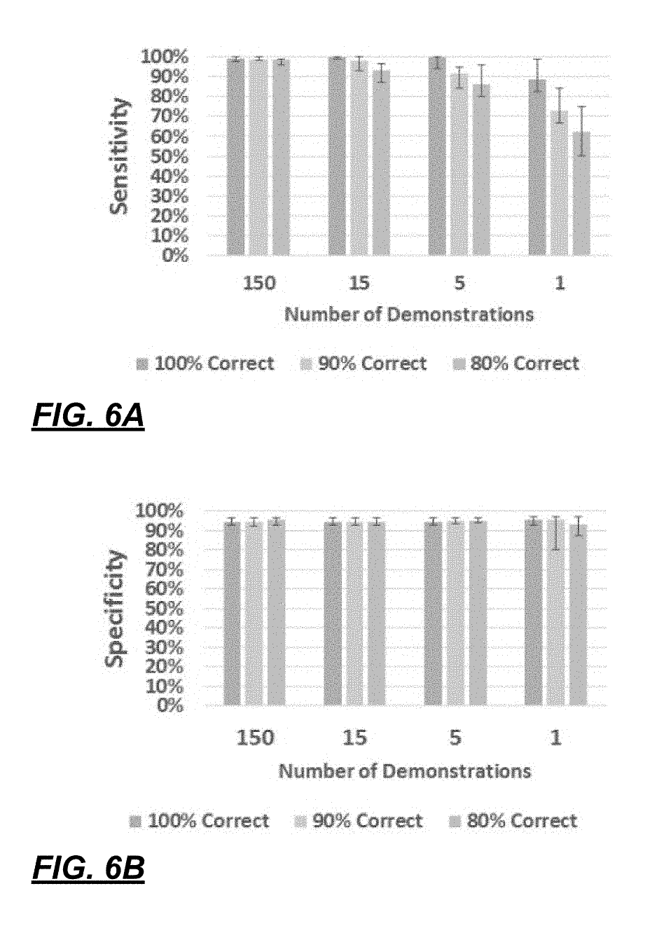

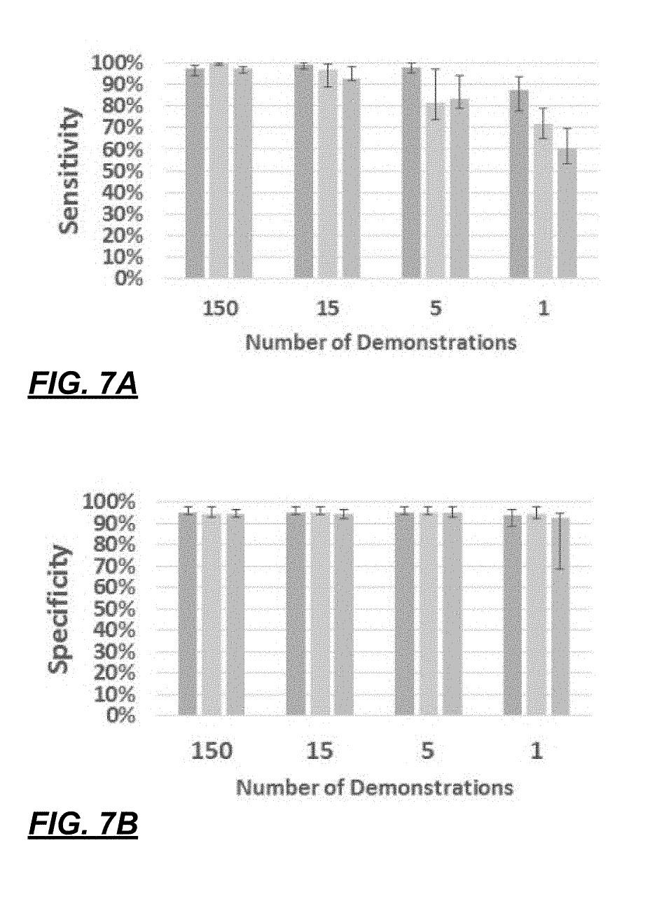

The sensitivity and specificity of the fully trained apprenticeship scheduling algorithm are depicted in FIGS. 6A and 6B for 1, 5, 15, and 150 scheduling demonstrations with homogeneous agents, and in FIGS. 7A and 7B for demonstrations with heterogeneous agents. As before, we also varied the quality of the training examples, assuming the demonstrator was operating under an ε-greedy approach with a (1−ε) probability of selecting the correct task to schedule and selecting another task from a uniform distribution otherwise.

For both the homogeneous and heterogeneous cases, we found that the apprenticeship scheduling algorithm was able to average ≧90% sensitivity and specificity either with five perfect schedules or 15 schedules generated by an operator making mistakes 20% of the time. Hyperparameter tuning substantially increased the sensitivity of the model from 59% to 82% for five scheduling examples generated by an operator making mistakes 20% of the time. (Recall that a schedule consists of allocating 20 tasks to two workers and sequencing those tasks in time.)

Through our synthetic evaluation, we have shown that our apprentice scheduling algorithm is able to learn to make sequential decisions that accurately emulate the decision making process of a mock expert. The apprenticeship scheduler model shows a robust ability to learn from sparse, noisy data. In the following sections, we describe the ability of the apprentice scheduler to learn from scheduling demonstrations produced by experts performing real-world scheduling tasks.

### 4.2 Real-World Data Set: Labor and Delivery

Currently, nurse resource managers commonly operate without technological decision-making aids. As such, it is imprudent to introduce a fully autonomous solution for resource management, as doing so could have life-threatening consequences for practitioners unfamiliar with such automation. Rather, research has shown that a semi-autonomous system is preferable when integrating machines into human cognitive workflows. Such a system would provide recommendations that a human supervisor could then accept or modify.

We found it prudent to test our apprenticeship scheduling technique with the algorithm offering recommendations to labor nurses who would evaluate how acceptable they found the quality of each recommendation. Specifically, we wanted to test whether the algorithm was able to learn to differentiate between high- and low-quality resource management decisions. If nurses accepted what the apprenticeship scheduler had learned to be high-quality advice while rejecting what the scheduler had learned to be low-quality advice, we could be reasonably confident that the apprentice scheduler had captured the desired resource management policy.

The first step, then, was to train a decision tree using the pairwise scheduling model based on the data set described in Section 3.2.1 of resource nurses' scheduling decisions. Recall that this data set consisted of the results of expert resource nurses playing the simulation for 212 hours, simulating 60 hours of elapsed time on a real labor floor, and yielding a data set of more than 3,013 individual decisions.

Second, we invited 15 labor nurses, none of whom were among those involved in training the algorithm, to play the same simulation used to collect the data. However, instead of purely soliciting decisions from the player, the simulation used the apprenticeship scheduling policy to offer recommendations about how to manage patients. Specifically, whenever a new patient arrived in the simulated waiting room, the apprenticeship scheduler would offer advice recommending 1) which of six wards to admit that patient to, 2) which bed within that ward to place that patient, and 3) which nurse should care for that patient. Nurses would then either accept the advice, automatically implementing the decision, or reject the advice and implement their own decisions.

In order to generate high-quality advice, the apprenticeship scheduler simply applied Equation 19. To generate low-quality advice, the apprenticeship scheduler applied Equation 18, which changes the maximization to a minimization, as follows:

$${τ}_{i}^{*} = {arg min}_{{τ}_{i} ∈ τ} {\sum }_{{τ}_{x} ∈ τ} {f}_{priority} ( {τ}_{i} , {τ}_{x} ) \qquad ( 18 )$$

However, such a minimization could create a straw-man counterpoint to the high-quality advice, demonstrating only that the apprenticeship scheduler learned at least hard constraints (e.g., “do not assign a patient to an occupied bed”) rather than a gradation over feasible actions (e.g., “assign a less-busy nurse to a new patient rather than a busier nurse”). As such, we also used the apprenticeship scheduler to generate low-quality but feasible advice. We accomplished this by only considering τᵢ∈τ such that τᵢ was feasible, as determined through a manually-encoded schedulability test.

For each of the 15 nurse players, we conducted two trials with the simulation offering advice. In one trial, the advice would be high-quality; in the other, the simulation offered low-quality advice that was randomly chosen to be low-quality but feasible or low-quality and infeasible. We hypothesized that nurses would accept advice during the high-quality trials and reject advice during the low-quality trials (regardless of feasibility). Each simulation trial was randomly generated, with each player experiencing different scenarios with differing advice. On average, a nurse would receive 8.5 recommendations per trial, resulting in a total of 256 recommendations across all nurses and trials.

The nurses accepted high-quality advice 88.4% of the time (114 of 129 high-quality recommendations), while rejecting low-quality advice 88.2% of the time (112 of 127 low-quality recommendations), indicating that the apprenticeship scheduling technique is able to learn a high-quality model for resource management decision making in the context of labor and delivery. In other words, the apprenticeship scheduler was able to learn context-specific strategies for hospital resource allocation problems and apply them to make reasonable suggestions about which tasks to perform and when.

Some of the advice was not accepted for reasons that can be easily remedied. For example, upon initiation of the test, we were unaware that one particular room on the labor and delivery floor was unique because it uniquely contained cardiac monitoring equipment. As such, the algorithm did not know to reason about that feature and sometimes offered a recommendation that was feasible but less preferable for patients with cardiac-related comorbidities. It was not until later that we learned from the nurses about this particular feature. Such findings motivate the need for active learning for improved feature solicitation in future work. We also note that inter-operator agreement among nurse demonstrators is unlikely to be 100%. For these reasons, we believe learning a policy that can generate advice validated to be correct nearly 90% of the time is a favorable result.

### 5 Model for Collaborative Optimization Via Apprenticeship Scheduling

Apprenticeship scheduling is designed to simply emulate human expert scheduling decisions. Herein, we also use the apprenticeship scheduler in conjunction with optimization to automatically and efficiently produce optimal solutions to challenging real-world scheduling problems. Our approach, called Collaborative Optimization via Apprenticeship Scheduling (COVAS), involves applying apprenticeship scheduling to generate a favorable (if suboptimal) initial solution to a new scheduling problem. To guarantee that the generated schedule is serviceable, we augment the apprenticeship scheduler to solve a constraint satisfaction problem, ensuring that the execution of each scheduling commitment does not directly result in infeasibility for the new problem. COVAS uses this initial solution to provide a tight bound on the value of the optimal solution, substantially improving the efficiency of a branch-and-bound search for an optimal schedule.

We show that COVAS is able to leverage good (but imperfect) human demonstrations to quickly produce globally optimal solutions. We also show that COVAS can transfer an apprenticeship scheduling policy learned for a small problem to optimally solve problems with twice as many variables as any shown during training, and produce an optimal solution an order of magnitude faster than mathematical optimization alone.

Here, we provide an overview of the COVAS architecture and present its two components: the policy learning and optimization routines.

### 5.1 COVAS Architecture

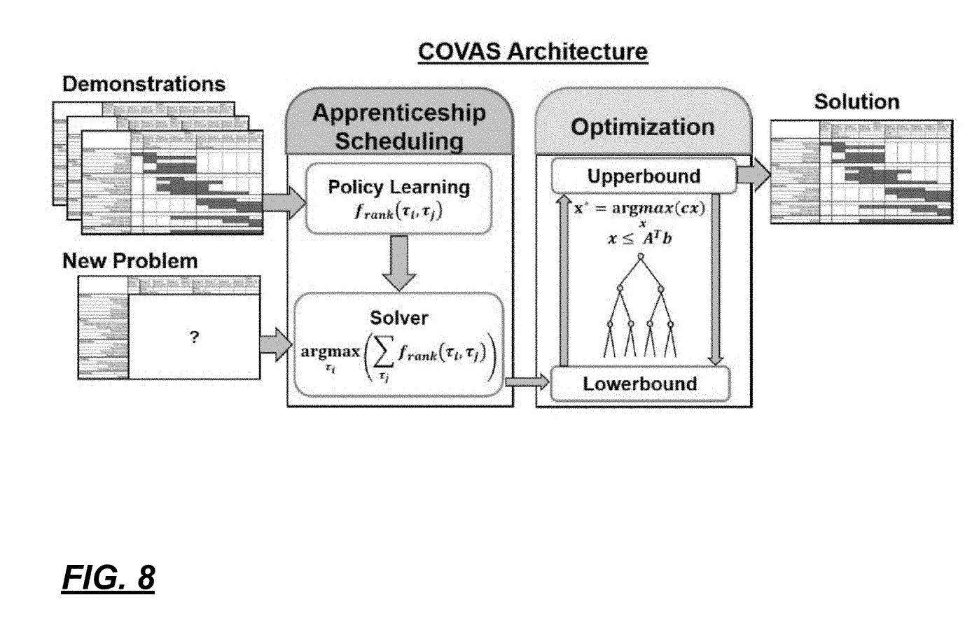

FIG. 8 depicts an example architecture for a COVAS system. The system takes as input a set of domain expert scheduling demonstrations (e.g., Gantt charts) that contains information describing which agents complete which tasks, when and where. These demonstrations are passed to an apprenticeship scheduling algorithm that learns a classifier, f_{priority}(τᵢ, τⱼ), to predict whether the demonstrator(s) would have chosen scheduling action τᵢ over action τⱼ∈T.

Next, COVAS uses f_{priority}(τᵢ, τⱼ) to construct a schedule for a new problem. The system creates an event-based simulation of this new problem and runs this simulation in time until all tasks have been completed. In order to complete tasks, COVAS uses f_{priority}(τᵢ, τⱼ) at each moment in time to select the best scheduling action to take. We describe this process in detail in the next section.

COVAS then provides this output as an initial seed solution to an optimization subroutine (i.e., a MILP solver). The initial solution produced by the apprenticeship scheduler improves the efficiency of a search by providing a bound on the objective function value of the optimal schedule. This bound informs a branch-and-bound search over the integer variables, enabling the search algorithm to prune areas of the search tree and focus its search on areas that can yield the optimal solution. After the algorithm has identified an upper- and lower-bound within some threshold, COVAS returns the solutions that have proven optimal within that threshold. Thus, an operator can use COVAS as an anytime algorithm and terminate the optimization upon finding a solution that is acceptable within a provable bound.

### 5.2 Apprenticeship Scheduling Subroutine

In Section 2, we presented our apprenticeship scheduling algorithm, which is centered around learning a classifier, f_{priority}(τᵢ, τⱼ), to predict whether an expert would take scheduling action τᵢ over τⱼ. With this function, we can then predict which single action τᵢ* amongst a set of actions τ the expert would take by applying Equation 19:

$${τ}_{i}^{*} = {argmax}_{{τ}_{i} ∈ τ} {\sum }_{{τ}_{x} ∈ τ} {f}_{priority} ( {τ}_{i} , {τ}_{x} ) \qquad ( 19 )$$

In this section, we build upon this formulation and integrate it into our collaborative-optimization via apprenticeship scheduling framework.

As a subroutine within COVAS, f_{priority}(τᵢ, τⱼ) is applied to obtain the initial solution to a new scheduling problem as follows: First, the user must instantiate a simulation of the scheduling domain; then, at each time step in the simulation, take the scheduling action predicted by Equation 19 to be the action that the human demonstrators would take. This equation identifies the task τᵢ with the highest importance marginalized over all other tasks τⱼ∈τ.

Unlike our original formulation in Section 2, each selected action is validated using a schedulability test (i.e., solving a constraint satisfaction problem) to ensure that direct application of that action does not violate the constraints of the new problem. This test must be fast, so as to make the benefit to feasibility and optimality in the resulting schedule worth the additional complexity. If, at a given time step, τᵢ* does not pass the schedulability test, COVAS uses Equation 19 for all τᵢ∈τ\τᵢ* to consider the second-best action. If no action passes the schedulability test, no action is taken during that time step.

While the schedulability test forces the apprenticeship scheduling algorithm to follow a subset of the full constraints in the MILP formulation, it is possible that the algorithm may not successfully complete all tasks. Here, we model tasks as optional and use the objective function to maximize the total number of tasks completed. In turn, constraints for a task that the apprenticeship scheduling algorithm did not satisfactorily complete can be turned off, with a corresponding penalty in the objective function score. Thus, an initial seed solution that has not completed all tasks (i.e., satisfied all constraints to complete the task) can still be helpful for seeding the MILP.

### 5.3 Optimization Subroutine

For optimization, we employ mathematical programming techniques to solve mixed-integer linear programs via branch-and-bound search. COVAS incorporates the solution produced by the apprenticeship scheduler to seed a mathematical programming solver with an initial solution. This is a built-in capability provided by many off-the-shelf, state-of-the-art MILP solvers, including CPLEX and Gurobi. This seed provides a tight bound on the value of the optimal solution, which serves to dramatically cut the search space, allowing the system to more quickly hone in on the area containing the optimal solution and, in turn, more quickly solve the optimization problem. Furthermore, this approach allows COVAS to quickly achieve a bound on the optimality of the solution provided by the apprenticeship scheduling subroutine. In such a manner, an operator can determine whether the apprenticeship scheduling solution is acceptable or whether waiting for successive solutions is warranted.

The techniques described herein can be implemented in digital electronic circuitry, or in computer hardware, firmware, software, or in combinations thereof. The techniques can be implemented as a computer program product, i.e., a computer program tangibly embodied in non-transitory medium such as a machine-readable storage device, or to control the operation of a data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the techniques described herein can be implemented on a computer, mobile device, smartphone, tablet, and the like having a display device, e.g., a CRT (cathode ray tube) or LCD (liquid crystal display) monitor, for displaying information to the user and an input device, e.g., a keyboard, touchscreen, touchpad, mouse or trackball, by which the user can provide input to the computer or other device (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD-ROM, a CD-RW, a CD-R, a DVD-ROM, a DVD-RW, a DVD-R, a flash memory card, a PROM, a RAM, a ROM, or a magnetic tape. In general, the computer-readable programs may be implemented in any programming language. The software programs may be further translated into machine language or virtual machine instructions and stored in a program file in that form. The program file may then be stored on or in one or more of the articles of manufacture.

Certain embodiments of the present invention are described above. It is, however, expressly noted that the present invention is not limited to those embodiments, but rather the intention is that additions and modifications to what is expressly described herein are also included within the scope of the invention. Moreover, it is to be understood that the features of the various embodiments described herein are not mutually exclusive and can exist in various combinations and permutations, even if such combinations or permutations are not made express herein, without departing from the spirit and scope of the invention. In fact, variations, modifications, and other implementations of what is described herein will occur to those of ordinary skill in the art without departing from the spirit and the scope of the invention. As such, the invention is not to be defined only by the preceding illustrative description, but rather by the claims.

We claim:

1. A method for task scheduling using domain expert heuristics captured within a computational framework, the method performed on at least one computer having a memory and a processor executing instructions stored in the memory, the method comprising:
training one or more classifiers to predict (i) whether a first action should be scheduled instead of a second action using pairwise comparisons between actions scheduled by a demonstrator at particular times and actions not scheduled by the demonstrator at the particular times, and (ii) whether a particular action should be scheduled for a particular agent at a particular time; and
generating a schedule for a set of actions to be performed by a plurality of agents using a plurality of resources over a plurality of time steps, wherein generating the schedule comprises using the one or more classifiers to determine (i) a highest priority action in the set of actions, and (ii) whether the highest priority action should be scheduled for a particular agent at a particular time step.

2. The method of claim 1, wherein training the one or more classifiers further comprises:
receiving a set of observations occurring over a plurality of times for a training action set, each observation comprising (i) features describing a state of each action in the training action set at one of the times and (ii) information identifying an action in the training action set scheduled at that time by a demonstrator, if any; and
training the one or more classifiers based at least in part on the observations.

3. The method of claim 2, wherein training the one or more classifiers further comprises transforming each observation into a set of new observations by performing pairwise comparisons between the action scheduled by the demonstrator at that time and other actions not scheduled by the demonstrator at that time.

4. The method of claim 3, wherein performing the pairwise comparisons comprises creating a positive example for each observation in which an action was scheduled by computing a difference between corresponding values in a first feature vector describing a scheduled action in that observation and a second feature vector describing an unscheduled action in that observation.

5. The method of claim 3, wherein performing the pairwise comparisons comprises creating a negative example for each observation in which an action was not scheduled by computing a difference between corresponding values in a first feature vector describing an unscheduled action in that observation and a second feature vector describing a scheduled action in that observation.

6. The method of claim 1, wherein the one or more classifiers are trained using positive examples from observations in a set of observations in which an action was scheduled and negative examples from observations in a set of observations in which no action was scheduled.

7. The method of claim 1, wherein the resources comprise resources shared among the agents.

8. The method of claim 1, wherein each action in the set of actions comprises a task, an agent, and a resource.

9. The method of claim 1, wherein each action in the set of actions comprises one or more scheduling-relevant features including deadline, earliest time available, precedence, duration, resource required, and dependence on other action.

10. The method of claim 1, further comprising configuring the plurality of agents to perform the set of actions according to the schedule.

11. A system for task scheduling using domain expert heuristics captured within a computational framework, the system comprising:
at least one memory for storing computer-executable instructions; and
at least one processor for executing the instructions stored on the at least one memory, wherein execution of the instructions programs the at least one processor to perform operations comprising:
training one or more classifiers to predict (i) whether a first action should be scheduled instead of a second action using pairwise comparisons between actions scheduled by a demonstrator at particular times and actions not scheduled by the demonstrator at the particular times, and (ii) whether a particular action should be scheduled for a particular agent at a particular time; and
generating a schedule for a set of actions to be performed by a plurality of agents using a plurality of resources over a plurality of time steps, wherein generating the schedule comprises using the one or more classifiers to determine (i) a highest priority action in the set of actions, and (ii) whether the highest priority action should be scheduled for a particular agent at a particular time step.

12. The system of claim 11, wherein training the one or more classifiers further comprises:
receiving a set of observations occurring over a plurality of times for a training action set, each observation comprising (i) features describing a state of each action in the training action set at one of the times and (ii) information identifying an action in the training action set scheduled at that time by a demonstrator, if any; and
training the one or more classifiers based at least in part on the observations.

13. The system of claim 12, wherein training the one or more classifiers further comprises transforming each observation into a set of new observations by performing pairwise comparisons between the action scheduled by the demonstrator at that time and other actions not scheduled by the demonstrator at that time.

14. The system of claim 13, wherein performing the pairwise comparisons comprises creating a positive example for each observation in which an action was scheduled by computing a difference between corresponding values in a first feature vector describing a scheduled action in that observation and a second feature vector describing an unscheduled action in that observation.

15. The system of claim 13, wherein performing the pairwise comparisons comprises creating a negative example for each observation in which an action was not scheduled by computing a difference between corresponding values in a first feature vector describing an unscheduled action in that observation and a second feature vector describing a scheduled action in that observation.

16. The system of claim 11, wherein the one or more classifiers are trained using positive examples from observations in a set of observations in which an action was scheduled and negative examples from observations in a set of observations in which no action was scheduled.

17. The system of claim 11, wherein the resources comprise resources shared among the agents.

18. The system of claim 11, wherein each action in the set of actions comprises a task, an agent, and a resource.

19. The system of claim 11, wherein each action in the set of actions comprises one or more scheduling-relevant features including deadline, earliest time available, precedence, duration, resource required, and dependence on other action.

20. The system of claim 11, wherein the operations further comprise configuring the plurality of agents to perform the set of actions according to the schedule.
